(19) United States
(12) Patent Application Publication
(10) Pub. No.: US 2009/0026179 A1
(43) Pub. Date: Jan. 29, 2009

(54) Thermal Cutting Method

(76) Inventors: Wolfgang DANZER, (US); Ernst Miklos, (US)

Correspondence Address: The BOC Group, Inc., 575 MOUNTAIN AVENUE, MURRAY HILL, NJ, 07974-2082, US

(21) Appl. No.: 12/172,432

(22) Filed: Jul. 14, 2008

(30) Foreign Application Priority Data
Jul. 26, 2007 (DE) 102007035393.8

(51) Int. Cl. B23K 9/00

(52) U.S. Cl. 219/121.44

(57) ABSTRACT

The invention pertains to a thermal cutting method, in which a cutting gas is introduced into a cutting nozzle and guided onto the work piece to be processed by means of the cutting nozzle, wherein the invention is characterized in that multiple changes of the cutting gas composition are realized during the cutting process.

### CROSS REFERENCE TO RELATED APPLICATIONS

This application claims priority from German Patent Application Serial No. 102007035393.8, filed Jul. 26, 2007.

### BACKGROUND OF THE INVENTION

The present invention pertains to a thermal cutting method, in which a cutting gas is introduced into a cutting nozzle and guided onto the work piece to be processed by means of the cutting nozzle.

Various thermal cutting methods are known. In thermal cutting, work pieces are cut by supplying energy to the location of the work piece to be cut such that material is removed from the work piece at the location to be processed. The material to be removed is expelled with the aid of the cutting gas jet.

Thermal cutting methods are contactless material processing methods and therefore have the advantage that the cutting tool is not subjected to any wear.

Thermal cutting methods are classified in accordance with the type of energy supply.

In flame cutting, the material is heated to the inflammation temperature with a fuel gas-oxygen flame or fuel gas-air flame and burned in the cutting oxygen flow or in a cutting gas flow containing oxygen. The burning of the material in the cutting oxygen results in energy being supplied to the cutting process in addition to the flame. The kinetic energy of the oxygen jet is also used for expelling the cinder created due to the burning of the material and the molten material.

Plasma arc cutting primarily is a melting process, in which the base material is melted by the plasma arc and also evaporated. The term plasma arc refers to an ionized and dissociated gas jet that is constricted by a cooled nozzle. A plasma jet with high energy density is obtained due to the constriction. The base material is instantaneously melted in the kerf by the plasma jet and thrown out of the gap being created by the plasma gas. The cooling of the nozzle required for the constriction is usually realized either with water and/or with a secondary gas that envelops the plasma jet. The secondary gas flows around the plasma arc in the form of a gas envelope and additionally constricts the plasma arc such that the cutting quality and the cutting speed are improved. An adequate cutting performance is achieved with systems that also use a secondary gas as cooling gas. One variation of plasma cutting with a secondary gas is microjet plasma cutting, in which the plasma jet is highly constricted. In addition, it is possible to further constrict the plasma jet by means of additional water injection. The molten material is expelled due to the high kinetic energy of the plasma gas. If a secondary gas is used, this gas also blows out the liquid material. Argon, nitrogen, hydrogen and mixtures thereof are typically used as plasma gas. Oxygen is also added to the plasma gas in certain instances, wherein the oxygen can lead to oxidation with the material such that an additional energy input is realized. The gas may also consist of compressed air. Occasionally, carbon dioxide is also added. If a secondary gas is used, it also consists of one of the aforementioned gases or a mixture thereof. The gas used or the gas composition depends on the respective type of cutting method and, in particular, the thickness and the type of the material to be cut.

In laser beam cutting, a laser beam is used as the cutting tool. This is realized by pointing the laser beam at the desired location, wherein this is usually realized by focusing the laser beam on the surface of the work piece to be cut or in the interior of the work piece with the aid of a lens in the cutting head such that the material to be cut is rapidly heated due to the high energy density. In laser beam fusion cutting, the material is heated to the melting temperature, wherein the material is heated to the evaporation temperature in laser sublimation cutting. Laser beam cutting with oxygen is a technique, in which oxygen is supplied to the location to be cut in order to input additional energy produced by burning the oxygen with the material analogous to flame cutting. To this end, the laser beam continuously heats the work piece to the inflammation temperature at the location being processed such that the work piece material can burn with the cutting oxygen. In laser beam cutting, the molten material is expelled from the kerf by the cutting gas, wherein the cutting oxygen jet also expels the cinder being produced in addition to the molten material in laser beam cutting with oxygen. In laser beam cutting with oxygen, the cutting gas consists of oxygen, wherein nitrogen, argon and/or helium are otherwise used as cutting gas in most instances. Compressed air is also used. A laser beam is an ideal tool for cutting thin metallic and non-metallic materials. However, the cutting speed of the laser beam decreases significantly as the material thickness increases. For example, sheet metal with a thickness of approximately two millimeters can be cut six-times faster than sheet metal with a thickness of approximately fifteen millimeters by means of laser beam cutting with oxygen.

In laser beam cutting, the cutting speed can be increased by supplying the cutting gas in a turbulent flow. For example, publication DE 43 36 010 A1 discloses a laser cutting device, in which a primary auxiliary gas and a secondary auxiliary gas are supplied by means of a processing head in such a way that the overall gas flow is in a turbulent flow state. It is also known from DE 10 2004 052 323 A1 that the cutting speed or the sheet metal thickness to be cut can be increased with a modulated movement of the cutting head. This can also be achieved with a modulation of the laser power and the gas pressure that is not described in detail. Publication DE 10 2005 049 010 A1 discloses a laser beam cutting method, in which a pressure modulation of the cutting gas flow is realized by using sound waves or an electric gas discharge.

With respect to plasma cutting, it is known from SU 1683927 to pulse the plasma jet by changing the electric current used for producing the plasma arc. It is furthermore known from GB 2194190 to modulate a supersonic plasma jet in such a way that a perforation can be cut or welded. To this end, the energy density alternately lies above and below the cutting or welding threshold, respectively. This is realized with a modulation of the gas flow or a modulation of the electric power for operating the plasma arc.

With respect to flame cutting, publication DE 101 48 168 A1 discloses a method, in which the cutting gas flows turbulently in the kerf. In this case, the turbulence of the gas flow is realized by means of pulsing with a valve or by means of another discontinuous gas flow. Document SU 812461 discloses pulsed secondary oxygen flows that are added to a primary oxygen flow at a certain angle in a cutting method. Document EP 533 387 A2 describes a device and a method for oxygen cutting, particularly for laser cutting with oxygen, in which an auxiliary gas is supplied to the cutting device in the form of gas pulses.

### BRIEF SUMMARY OF THE INVENTION

The present invention is based on the objective of making available a thermal cutting method that is improved with respect to the cutting quality and the stability of the cutting process, namely also at high cutting speeds and when cutting thick sheet metals.

This objective is attained in that multiple changes of the cutting gas composition are realized during the cutting process. The change of the composition of the cutting gas significantly improves the process stability. Furthermore, the pulsating cutting gas flow produced by the change of the cutting gas composition advantageously increases the maximum attainable cutting speed, wherein it is particularly advantageous that this can be realized without significantly increasing the energy input per unit length, i.e., the energy input into the work piece per length of the cut.

The reference to a multiple periodic change serves for clearly distinguishing the present invention from simple switch-off and switch-on processes at the beginning and at the end of the cutting process, as well as from simple flushing processes. In this context, the term multiple refers to at least 10-times, preferably at least 20-times, particularly at least 50-times. It is particularly advantageous to realize the described changes over the entire duration of a cutting process.

In this case, the change of the gas composition may be realized by switching at least one component off and on, as well as a multiple temporary reduction of at least one component. For example, when using a mixture that consists of the components A and B, only the component A is occasionally supplied. In other words, the component A is periodically switched off and on several times. For example, the component B may then also be switched off and switched on again, wherein the times at which the component B is switched off and on are shifted relative to the times at which the component A is switched off and on, particularly in such a way that the components A and B alternate. It would also be possible, for example, to switch the component A off and on while the component B is supplied in an unchanged fashion. Another exemplary option consists of switching the component A off and on and simultaneously reducing the component B. It would also be possible, for example, to occasionally reduce the component A or B by a different amount than the other component such that the composition is changed. It is also possible to utilize mixtures with more than two components, wherein either only selected components or all components can be successively and/or simultaneously switched off and on or occasionally reduced with respect to their volumetric flow rate, and wherein a change of the volumetric flow rate of one or more components results in a change of the composition. In this case, at least a reduced amount of at least one component is always supplied to the location to be processed. One component of the cutting gas may, under certain circumstances, also consist of a gas mixture rather than a single gas such that the term partial flows could also be used instead of the term components in this context.

### DETAILED DESCRIPTION OF THE INVENTION

It was determined that the present invention makes it possible to significantly improve the quality of the cuts and the cutting edges in comparison with the state of the art. The process stability and the reproducibility of the method are additionally increased. The expulsion of the liquid metal and, if applicable, the cinder from the kerf takes place more efficiently, evenly and thoroughly than in the known methods. These improvements of the method make it possible to further increase the cutting speed without sacrificing the quality. Another advantage is realized, particularly in flame cutting: the oxide skin formed in the kerf while the oxygen burns is consistently broken open due to the decrease of oxygen and the addition of a second gas, particularly an inert or low-activity gas, such that the oxygen consistently encounters a blank surface and can react therewith. This is a particularly distinct advantage in laser cutting with oxygen, but also in flame cutting and in plasma cutting with oxygen in plasma gas and/or secondary gas.

Multiple periodic changes of the composition of the cutting gas are preferably realized. It is particularly preferred to change the composition of the cutting gas with a constant period.

It is particularly preferred that the cutting gas is composed of at least two components, of which at least one is periodically switched off and on several times. When using two components, it is particularly preferred to switch these components off and on in such a way that they alternate. An alternation of the components can be realized in a particularly simple fashion and the advantages of the invention are attained in a superb fashion. Other options that also lead to the inventive advantages are described in a preceding paragraph. However, this listing is not exhaustive.

The change of composition is preferably achieved by alternately switching the components of the cutting gas off and on, wherein the duration of the switched-off state may be different from or identical to that of the switched-on state.

Instead of repeatedly switching the components off and on, the composition can also be changed by reducing and then once again increasing the volumetric flow rate of the individual components of the cutting gas through one or more supply lines.

When using nitrogen and oxygen, for example, the nitrogen is repeatedly switched off or at least reduced (a mere reduction can already lead to satisfactory results). In this example, the nitrogen pulse removes the oxide layer that was formed due to the contact of the work piece surface with the oxygen. Consequently, the work piece surface is subjected to continuous temporary cleaning and the cutting gas advantageously encounters a consistently blank surface. The oxygen flow can also be reduced or even switched off periodically, preferably anticyclic referred to the nitrogen flow.

This example can also be used in connection with other gases and compositions.

The cutting gas used advantageously consists of oxygen, nitrogen, argon, hydrogen or a mixture that contains at least one gas of this group. Carbon dioxide can also be used.

According to one advantageous additional development of the invention, multiple changes of the volumetric flow rate of the cutting gas are realized during the cutting process.

The advantages of the invention can be promoted by also changing the volumetric flow rate that is directed against the work piece.

According to one particularly advantageous embodiment of the invention, the change of the composition and, if applicable, the volumetric flow rate of the cutting gas is realized in a periodic sequence that is repeated in unchanged fashion. The change of the volumetric flow rate of the gas can be at least partially illustrated as a function of the time, e.g., by a rectangular, triangular or sinusoidal profile or a combination thereof. The change of the composition, e.g., of a two-component process gas may assume any curve shapes, particularly also those mentioned above. In this case, it is important to distinguish illustrations, in which one component of the process gas is respectively plotted on the x-axis and the y-axis of the illustration, from illustrations, in which the components are plotted in the y-direction and the time is plotted in the x-direction.

In certain applications, it may be particularly advantageous to use a sequence that is periodically repeated in modified form.

According to one advantageous additional development of the invention, the composition and, if applicable, the volumetric flow rate of the cutting gas are changed by means of at least one flow limiter and/or by means of at least one valve. It is advantageous to utilize, e.g., a valve that can be controlled or adjusted in an infinitely variable fashion. The change of the composition of the cutting gas is preferably realized with valves that can be controlled or adjusted in an infinitely variable fashion and are respectively arranged in the supply lines for the individual components of the cutting gas. Magnetic or piezoelectric valves are particularly suitable for this purpose. Another option consists of correspondingly switching on at least one additional gas flow. It would also be conceivable to use a bypass.

According to one preferred embodiment of the invention, the method is carried out with a periodicity of low frequency, preferably with frequencies up to 500 Hz, especially with frequencies in the range between 0.5 and 100 Hz, particularly with frequencies in the range between 1 and 50 Hz. Frequencies in the range between 3 and 20 Hz proved particularly effective in practical applications.

According to a very advantageous alternative embodiment of the invention, the method is carried out with a periodicity that has a frequency in the range between 500 Hz and 8000 Hz, preferably between 700 and 5000 Hz, particularly between 1000 and 3000 Hz. When using such high frequencies, a standing, oscillating pressure column is formed; a standing wave is created. The standing, oscillating pressure column makes it possible to realize an optimal pressure distribution and an increased transmission of energy onto the work piece. This represents a significant improvement in comparison with the known methods.

It is particularly advantageous to carry out the thermal cutting method according to the present invention by means of flame cutting, laser cutting, particularly laser cutting with oxygen and/or laser fusion cutting, and/or plasma cutting. The invention is also suitable for laser sublimation cutting.

In plasma cutting, the composition can be changed with the plasma gas and/or the secondary gas. In plasma cutting with plasma gas and a secondary gas, however, it is particularly advantageous to realize the change of the composition by modulating the secondary gas while the plasma gas remains unchanged during the cutting process.

The thermal cutting method can be advantageously optimized for specific applications with suitable optional combinations of the inventive embodiments.

When using a mixture of nitrogen and oxygen as cutting gas, for example, the cutting oxygen and the nitrogen can be switched off and switched on again in a periodically repeating and alternating fashion. This makes it possible to realize a particularly advantageous control of the oxidation processes, in which the oxide skin is destroyed by the nitrogen such that the oxygen then once again has unhindered access to the work piece. These advantages manifest themselves, in particular, in laser cutting with oxygen. These processes can be further optimized by also varying the overall volumetric flow rate of the cutting gas. It is particularly advantageous to switch the oxygen flow and/or the nitrogen flow off and on, e.g., by means of a piezoelectric valve that is designed for the preferred frequency ranges mentioned above.

According to another example, in which the cutting gas consists of a mixture of nitrogen and oxygen, the cutting oxygen and/or the nitrogen can be reduced in a periodically repeating fashion such that the oxygen content of the cutting gas and therefore the composition of the cutting gas are changed. This makes it possible to realize a particularly advantageous control of the oxidation processes, in which the oxide skin is destroyed by the nitrogen and the oxygen then once again has unhindered access to the work piece. These processes can be further optimized by also varying the overall volumetric flow rate of the cutting gas.

We claim:

1. A thermal cutting method, in which a cutting gas is introduced into a cutting nozzle and guided onto the work piece to be processed by means of the cutting nozzle, characterized in that multiple changes of the cutting gas composition are realized during the cutting process.

2. The method according to claim 1, characterized in that the composition of the cutting gas is changed in a periodically repeating fashion.

3. The method according to claim 1, characterized in that the cutting gas comprises at least two components, of which at least one component is switched off and on in a periodically repeating fashion.

4. The method according to claim 1, characterized in that the components of the cutting gas are alternately switched off and on.

5. The method according to claim 1, characterized in that the cutting gas used is selected from the group consisting of oxygen, nitrogen, argon, hydrogen or a mixture that contains at least one gas of this group.

6. The method according to claim 1, characterized in that multiple changes of the volumetric flow rate of the cutting gas are realized during the cutting process.

7. The method according to claim 1, characterized in that a valve is used.

8. The method according to claim 7 wherein said valve is selected from the group consisting of a magnetic or piezoelectric valve.

9. The method according to claim 1, characterized in that the method is carried out with a periodicity of low frequency.

10. The method according to claim 9, characterized in that the method is carried out with a periodicity that has frequencies up to 500 Hz.

11. The method according to claim 9, characterized in that the method is carried out with a periodicity that has frequencies between 0.5 and 100 Hz.

12. The method according to claim 9, characterized in that the method is carried out with a periodicity that has frequencies between 1 and 50 Hz.

13. The method according to claim 1, characterized in that the method is carried out with a periodicity that has a frequency in the range between 500 Hz and 8000 Hz.

14. The method according to claim 13, characterized in the method is carried out with a periodicity that has frequencies between 700 and 5000 Hz.

15. The method according to claim 13, characterized in the method is carried out with a periodicity that has frequencies between 1000 and 3000 Hz.

16. The method according to claim 1, characterized in that thermal cutting method is carried out by a means selected from the group consisting of flame cutting, laser cutting with oxygen, laser fusion cutting, and plasma cutting.
